(19) United States
(12) Patent Application Publication
(10) Pub. No.: US 2006/0195313 A1
(43) Pub. Date: Aug. 31, 2006

(54) Method and system for selecting and conjugating a verb

(75) Inventors: Eric J. Voetberg, Seattle, WA (US); Jinsong Yu, Sammamish, WA (US); Mark D. Stumpf, Auburn, WA (US); Robert E. Parkin, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/067,505

(22) Filed: Feb. 25, 2005

(51) Int. Cl. G06F 17/27

(52) U.S. Cl. 704/9

(57) ABSTRACT

A verb conjugating system allows a user to input a form of a verb and display the verb forms. The verb conjugating system allows the user to input the infinitive form or non-infinitive forms of a verb. When a user inputs a non-infinitive form of a verb, the verb conjugating system identifies a corresponding base form of the verb. The verb conjugating system then uses the base form to retrieve and display the verb forms for the verb. The verb conjugating system may highlight the non-infinitive form of the verb within the displayed verb forms to assist the user in locating the verb form of interest.

### TECHNICAL FIELD

The described technology relates generally to conjugating verbs and particularly to selecting a verb to conjugate when learning a language.

### BACKGROUND

Software tools are currently available to help a user who is learning a new language to conjugate verbs. Many of these software tools are available via the Internet. Although there are many variations of these software tools, they typically receive as input an infinitive form of a verb and display its verb forms. The verb forms may be identified by a verb form description that may include mood, tense, number, person, and gender. The moods may include indicative, subjunctive, and imperative; the tense may include past, present, and future and other tenses; the number may include singular and plural; the person may include first, second, and third; and the gender may include masculine, feminine, and neuter. The software tools typically use the infinitive form of a verb as an index into a table that contains the verb forms of that verb. Some software tools may even allow a user to input a non-infinitive form of a verb and then display the verb forms corresponding to that verb.

When a user inputs a verb, some software tools search multiple languages to determine whether the languages have a verb with the same spelling. For example, when a user inputs “comer,” the software tool may report that both Portuguese and Spanish have a verb with that spelling. The software tool allows the user to select the language of interest and then displays the verb forms of the input verb in the selected language.

Although these software tools may be useful in conjugating verbs, they have various limitations. For example, if a user misspells the infinitive form or non-infinitive form of a verb, then the software tools report an error. The reporting of an error can be quite frustrating to a user who is trying to learn a language and has made a simple spelling error. The user is effectively prevented from learning the correct spelling of that verb. As another example, a user who wants to see the verb forms in a target language (e.g., a language that the user is studying) for a certain verb, but only knows that verb in a base language (e.g., the user's native language), cannot obtain the verb forms directly. Rather, the user first needs to locate a base language to target language dictionary (e.g., a bilingual dictionary) and use the verb in the base language to locate the verb in the target language. Once the user has located a verb in the target language, then the user can input that verb to a software tool to conjugate the verb. As another example, some software tools for verb conjugating will locate matching infinitive forms of a verb in multiple languages. For example, if a user inputs “como,” which is a non-infinitive form, the software tool may display the infinitive forms of “comêre” for Latin and “comer” for both Portuguese and Spanish. The software tools may, however, search for only one matching verb for a language and display only the infinitive form of that verb even when multiple verbs match. As another example, some software tools may not display all tenses and moods of a verb. It would be desirable to have a technique for overcoming these and other limitations of existing software tools for conjugating verbs.

### SUMMARY

A verb conjugating system allows a user to input a form of a verb and display the verb forms. The verb conjugating system allows the user to input the infinitive form or non-infinitive forms of a verb. When a user inputs a non-infinitive form of a verb, the verb conjugating system identifies a corresponding base form of the verb. The verb conjugating system then uses the base form to retrieve and display the verb forms for the verb. The verb conjugating system may highlight the non-infinitive form of the verb within the displayed verb forms to assist the user in locating the verb form of interest. The verb conjugating system may also provide verb forms in a target language when a user enters a verb in a base language. The verb conjugating system identifies when a user enters a spelling of a verb that ambiguously specifies different verbs in a language. The verb conjugating system displays the infinitive form of the verbs that match and allows the user to select a verb of interest.

The verb conjugating system may also allow a user to input a phrase that includes a verb and will display the verb forms corresponding to the verb of the phrase. The verb conjugating system may also detect a misspelling of a verb form and provides suggestions for alternate spellings.

### BRIEF DESCRIPTION OF THE DRAWINGS

FIG. 1 is a display page that illustrates a search dialog box of the verb conjugating system in one embodiment.

FIG. 2 is a display page that illustrates the results of a search based on a verb in the base language in one embodiment.

FIG. 3 is a display page that illustrates the results of a search in the target language in one embodiment.

FIG. 4 is a display page that illustrates the results of a search that matches multiple verbs in one embodiment.

FIG. 5 is a display page that illustrates the results of selecting a matching verb in one embodiment.

FIG. 6 is a display page that illustrates the results of a search in which no matching spelling is found in one embodiment.

FIG. 7 is a display page that illustrates the results of a search based on a phrase that includes a pronoun in one embodiment.

FIG. 8 is a display page that illustrates the results of a search based on a phrase that includes an auxiliary in one embodiment.

FIG. 9 is a display page that illustrates the results of a search based on a word that is a verb in both the base language and the target language in one embodiment.

FIG. 10 is a block diagram illustrating components of the verb conjugating system in one embodiment.

FIG. 11 is a block diagram that illustrates tables used by the search system of the verb conjugating system in one embodiment.

FIG. 12 is a flow diagram that illustrates the processing of the process search request component in one embodiment.

FIG. 13 is a flow diagram that illustrates the processing of the perform search component in one embodiment.

### DETAILED DESCRIPTION

A method and system for conjugating verbs is provided. In one embodiment, a verb conjugating system allows a user to input a form of a verb and display the verb forms (conjugated verbs) of that verb. The verb conjugating system allows the user to input the infinitive form and non-infinitive forms of a verb. When a user inputs a non-infinitive form of a verb, the verb conjugating system identifies the corresponding base form (i.e., infinitive form) of the verb. The verb conjugating system then uses the base form to retrieve and display the verb forms for the verb. In one embodiment, the verb conjugating system may highlight the input non-infinitive form of the verb within the displayed verb forms to assist the user in locating the verb form of interest. The verb conjugating system may also initially scroll a window in which the verb forms are displayed so that the verb form of interest is visible. In this way, a user can search using the infinitive form or a non-infinitive form of a verb and readily identify a non-infinitive form of interest within the displayed verb forms.

In one embodiment, the verb conjugating system provides the verb forms in a target language when a user enters a verb in a base language. For example, a user who speaks English and is learning Spanish may have English as their base language and Spanish as their target language. Such a user may want to see the verb forms in Spanish that correspond to the English verb “eat.” When the user enters the verb “eat,” the verb conjugating system identifies that the translation of “eat” is “comer” in Spanish. The verb conjugating system then displays the verb forms in Spanish for the verb “comer.” The verb conjugating system may allow the user to enter verbs in either the base language or the target language and then displays the corresponding verb forms in the target language. In this way, the user does not need to use a separate bilingual dictionary when the user does not know a verb in the target language.

In one embodiment, the verb conjugating system identifies when a user enters a spelling of a verb that ambiguously specifies different verbs in a language. For example, when the target language is Spanish and the user enters the verb form “comieron,” the verb conjugating system identifies that the spelling actually matches a verb form of the verbs “comer” and “comerse.” The verb conjugating system displays the infinitive forms of the verbs that match and allows the user to select a verb of interest. The verb conjugating system may also display the definition of the matching verbs in either the base language or the target language to assist the user in selecting the verb that is of interest. For example, the verb conjugating system may display “eat” as the definition of “comer” and “skip” as the definition of “comerse.” When the user selects the verb of interest, the verb conjugating system displays the verb forms of the selected verb and may highlight the verb form that the user originally input. In this way, the verb conjugating system allows a user to see matching verbs and to select the matching verb of interest.

In one embodiment, the verb conjugating system allows a user to input a phrase that includes a verb and will display the verb forms corresponding to the verb of the phrase. For example, the phrase may include a pronoun and a verb (e.g., “you eat”) or an auxiliary and a verb (e.g., “had eaten”). The verb conjugating system may match the phrase to a corresponding phrase (e.g., “yo como”) in either the base language or the target language and display the corresponding verb forms of the verb in both languages. The verb conjugating system may highlight the phrase within the displayed verb forms.

In one embodiment, the verb conjugating system detects a misspelling of a verb form and provides suggestions for what the correct spelling may be. For example, when a user inputs “comr,” the verb conjugating system may suggest the verb forms of “comer,” “come,” “comb,” “coma,” “comi,” and “como.” The suggested spellings may correspond to words in either the base language or the target language. For example, the verb “come” is the correct spelling for verbs in both English and Spanish that have very different meanings. The verb conjugating system displays the suggested verbs and allows the user to select the verb to conjugate. The verb conjugating system may also display the definition of the verbs to assist the user in deciding which verb is really of interest. The verb conjugating system then displays the verb forms for the selected verb.

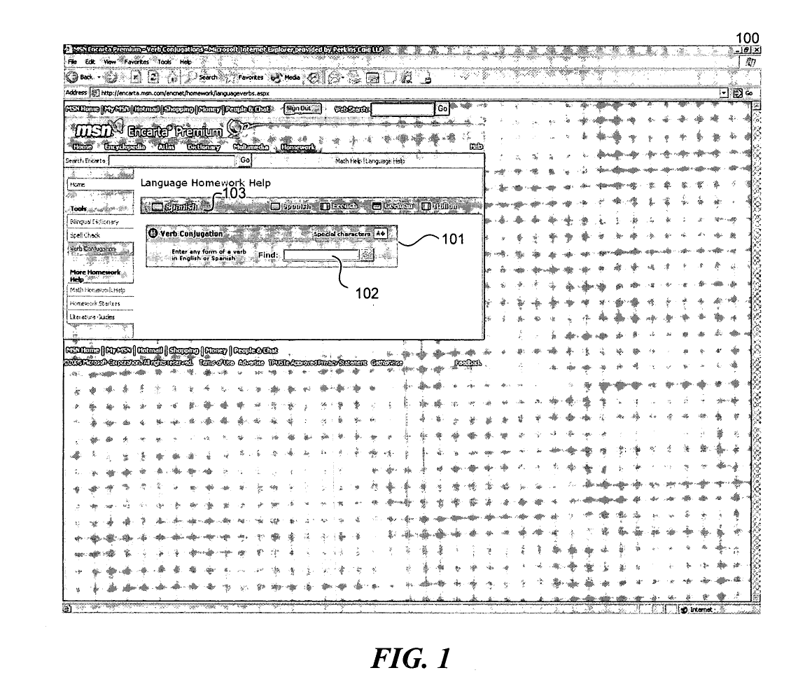

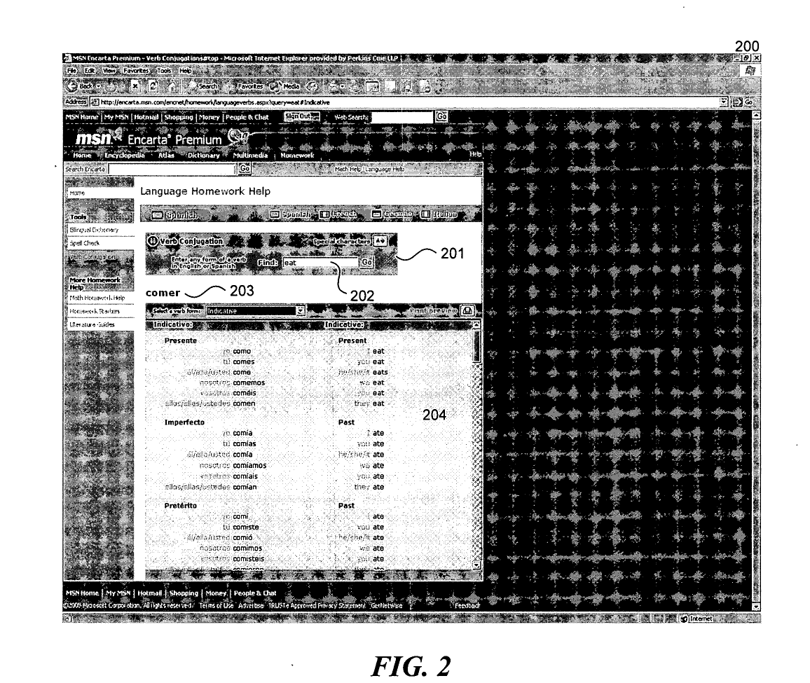

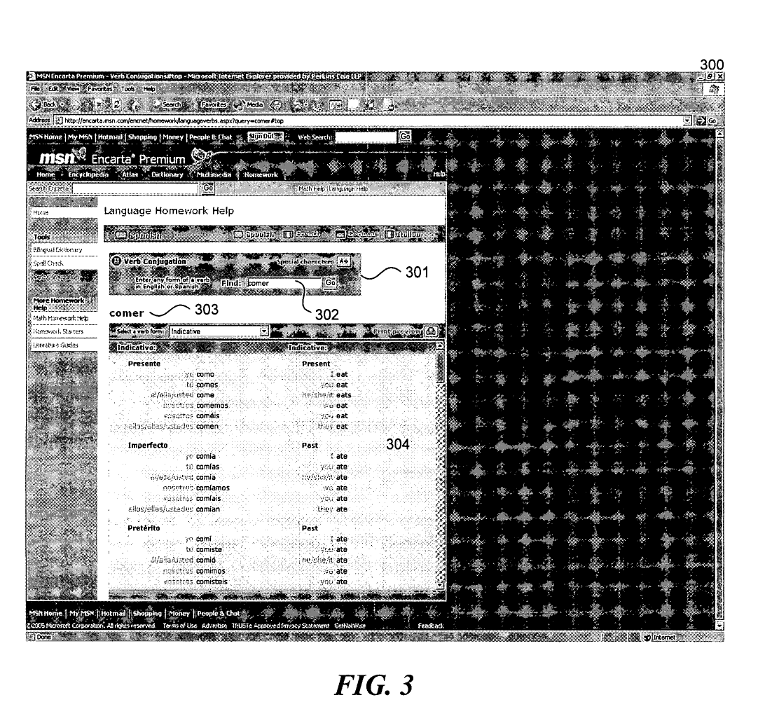

FIGS. 1-9 are display pages that illustrate the various aspects of the verb conjugating system in one embodiment. FIG. 1 is a display page that illustrates a search dialog box of the verb conjugating system in one embodiment. A display page 100 includes a search dialog box 101 and a text input field 102. In this example, the user has selected a target language of Spanish as indicated in the highlighted portion of the language bar 103. The base language is English. To search for verb forms, the user enters the infinitive form or non-infinitive form of a verb or a phrase in the text input field. The user then selects the go button to start the search. FIG. 2 is a display page that illustrates the results of a search based on a verb in the base language in one embodiment. A display page 200 includes a search dialog box 201, a text input field 202, an infinitive form area 203, and a verb form area 204. As indicated by the text input field, the user is searching for the verb forms in Spanish corresponding to the English verb “eat.” The infinitive form area indicates that the infinitive form of the corresponding Spanish verb is “comer.” The verb form area includes the verb form in both Spanish and English along with the corresponding pronouns and auxiliaries. FIG. 3 is a display page that illustrates the results of a search in the target language in one embodiment. A display page 300 includes a search dialog box 301, a text input field 302, an infinitive form area 303, and a verb form area 304. As indicated by the text input field, the user is searching for the verb forms in Spanish corresponding to the Spanish verb “comer,” which corresponds to the English verb “eat.” As such, the verb form area 304 contains the same content as the verb form area 204.

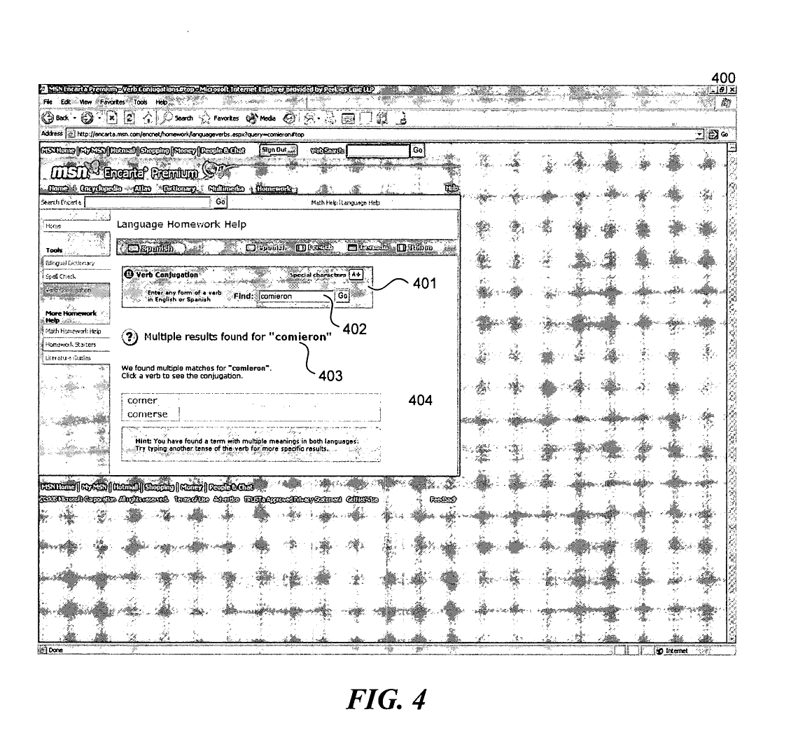

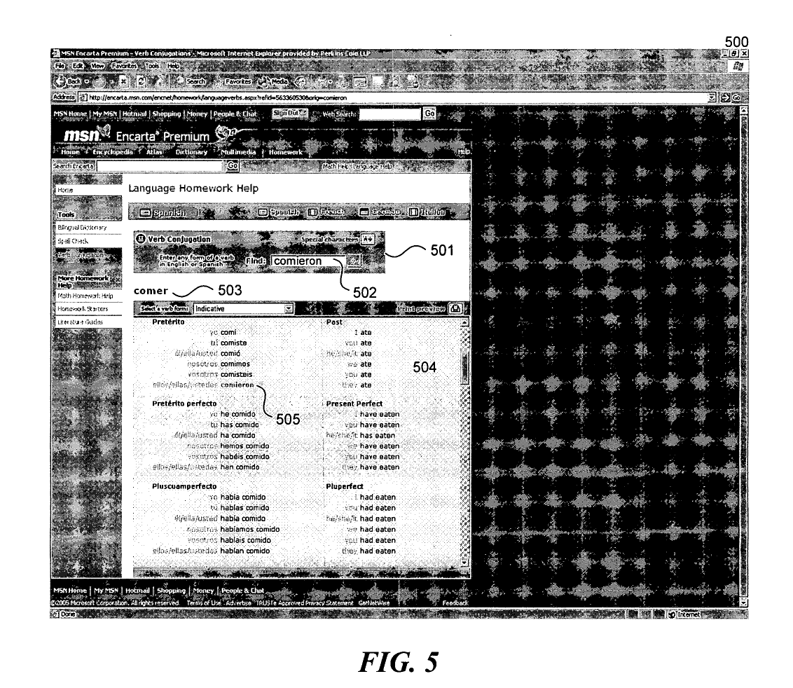

FIG. 4 is a display page that illustrates the results of a search that matches multiple verbs in one embodiment. A display page 400 includes a search dialog box 401, a text input field 402, an infinitive form area 403, and a matching verb area 404. As indicated by the text input field, the user is searching for “comieron,” which is a Spanish verb form. The Spanish verb form “comieron” matches the Spanish verbs “comer” and “comerse,” which are displayed in the matching verb area. Although not shown, the matching verb area may also include a definition of the verbs. The user selects a matching verb to view the corresponding verb forms. FIG. 5 is a display page that illustrates the results of selecting a matching verb in one embodiment. A display page 500 includes a search dialog box 501, a text input field 502, an infinitive form area 503, and a verb form area 504. As indicated by the text input field, the user was searching for the verb “comieron.” As indicated by the infinitive form area, the user selected the matching verb “comer.” The verb conjugating system highlighted the searched-for verb form 505 in the verb form area and scrolled the verb form area so that the searched-for verb form is initially visible to the user.

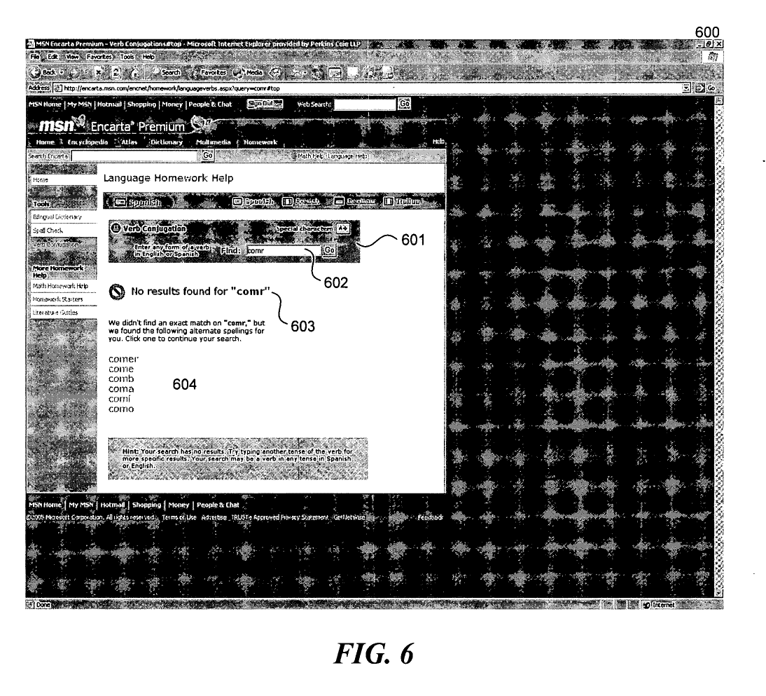

FIG. 6 is a display page that illustrates the results of a search in which no matching spelling is found in one embodiment. A display page 600 includes a search dialog box 601, a text input field 602, a no results area 603, and an alternate spelling area 604. As indicated by the text input field, the user is searching for the misspelled verb “comr.” The no results area indicates that no form of a verb in either the base language or the target language matches the spelling “comr.” The verb conjugating system identifies alternate spellings for the misspelled verb and displays the alternate spellings in the alternate spelling area. The verb conjugating system may also display the definition of the verbs with the alternate spellings. When a user selects a verb with an alternate spelling, the verb conjugating system then displays the verb forms for that selected verb.

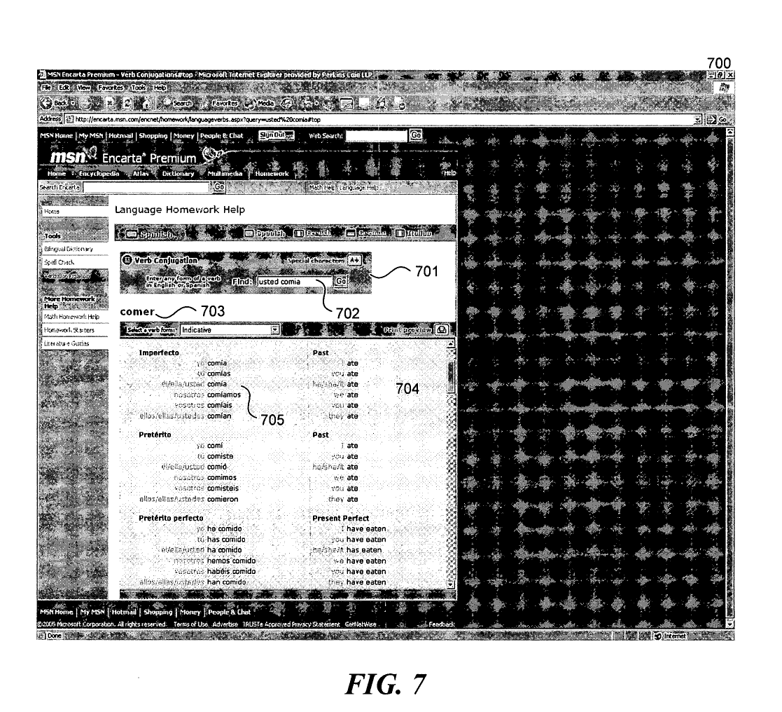

FIG. 7 is a display page that illustrates the results of a search based on a phrase that includes a pronoun in one embodiment. A display page 700 includes a search dialog box 701, a text input field 702, an infinitive form area 703, and a verb form area 704. As indicated by the text input field, the user is searching using the phrase “usted comia” with “usted” being the pronoun and “comia” being the verb. The verb conjugating system identifies the corresponding infinitive form of the verb as “comer” as indicated in the infinitive form area. The verb form area contains the corresponding verb forms. The verb conjugating system may also highlight and scroll to the phrase “usted comia” 705 (although not shown as highlighted in FIG. 7).

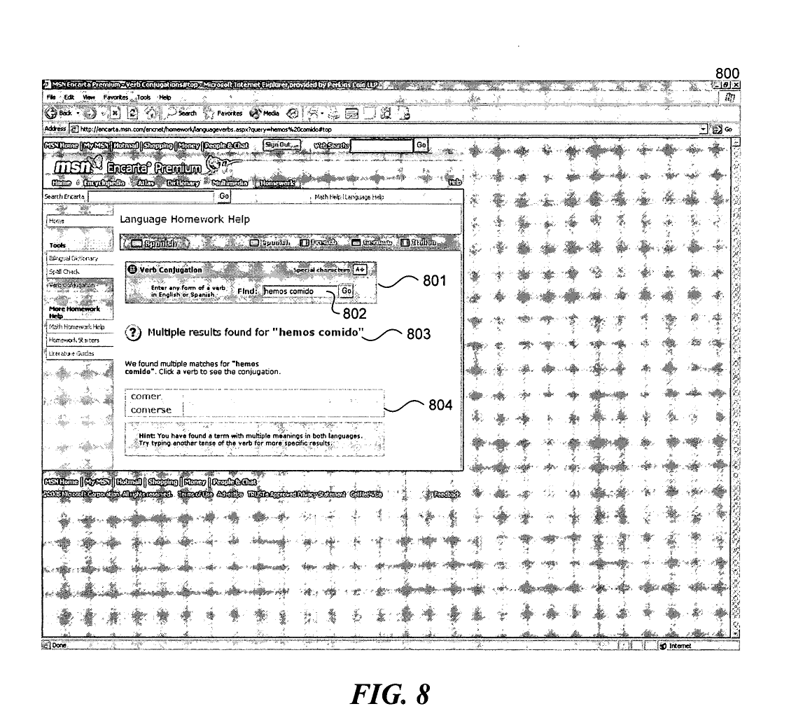

FIG. 8 is a display page that illustrates the results of a search based on a phrase that includes an auxiliary in one embodiment. A display page 800 includes a search dialog box 801, a text input field 802, a multiple found area 803, and a multiple results area 804. As indicated by the text input field, the user is searching using the phrase “hemos comido” with “hemos” being the auxiliary and “comido” being the verb. The verb conjugating system identified two verbs as matching and displayed the infinitive form of the verbs in the multiple results area as “comer” and “comerse.” When the user selects one of the verbs, the verb conjugating system displays the corresponding verb forms.

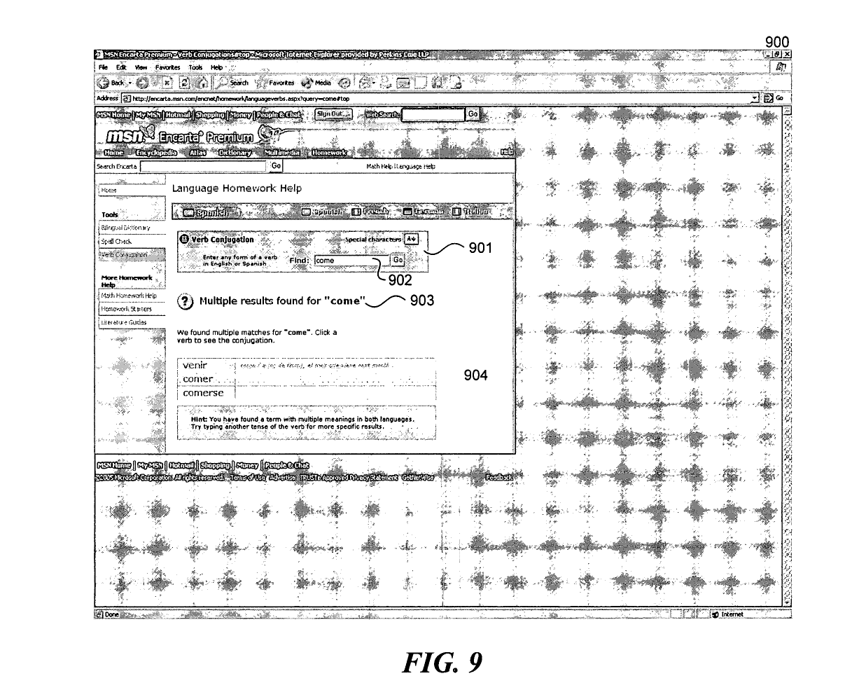

FIG. 9 is a display page that illustrates the results of a search based on a word that is a verb in both the base language and the target language in one embodiment. A display page 900 includes a search dialog box 901, a text input field 902, a multiple found area 903, and a multiple results area 904. As indicated by the text input field, the user is searching using the word “come,” which is the correct spelling of a verb form in both English and Spanish. The multiple found area indicates that multiple results were found for the verb. The multiple results area indicates that the verb form matches the verbs “venir,” “comer,” and “comerse” in Spanish. When a user selects one of the verbs, the verb conjugating system displays the corresponding verb forms.

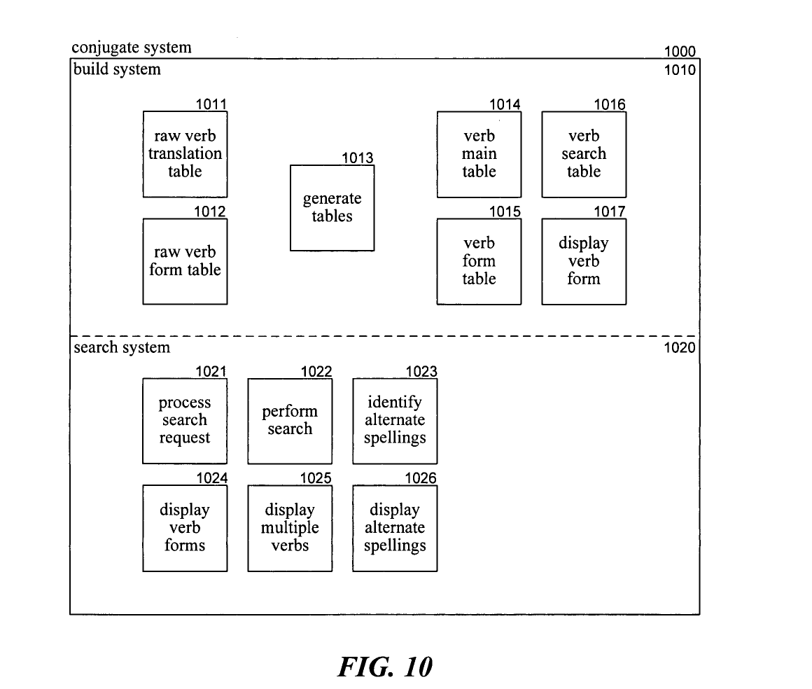

FIG. 10 is a block diagram illustrating components of the verb conjugating system in one embodiment. The verb conjugating system 1000 includes a build system 1010 and a search system 1020. The build system inputs verbs and their verb forms in the base language and the target language and generates data structures that are optimized for use by the search system. The search system provides the user interface for searching for and displaying verb forms. The build system includes a raw verb translation table 1011, a raw verb form table 1012, a generate tables component 1013, a verb main table 1014, a verb form table 1015, a verb search table 1016, and a display verb form table 1017. The generate tables component inputs the raw tables, generates tables that are optimized for searching, and provides those optimized tables to the search system. The raw verb translation table and the raw verb form table may be generated by an editor defining the verbs and their verb forms. The raw verb translation table may contain an entry for each form of a verb and its translation in both the base language and the target language. For example, the raw verb translation table may contain an entry that includes the verb “eat” and its translation “comer,” and another entry that contains the verb “eat” and its translation “como.” The raw verb form table contains an entry for each verb form that includes the verb form and verb form description (e.g., the combination of mood, tense, number, person, and gender) and may include a pronoun or an auxiliary. The verb main table includes an entry for the infinitive form of each verb in the target language. The entry includes the infinitive form, the translation of the infinitive form, and an indication of the language of the infinitive form and its translation. The verb form table includes an entry for each verb form of the target language. The entries include the verb form, the translated verb form, and the verb form description and may include a pronoun and translated pronoun, and an auxiliary and translated auxiliary. The entries also include a mapping to the corresponding infinitive form of the verb. The verb search table contains an entry for each verb form (including infinitive forms) and each phrase that can be searched in the base and target languages. The entries include the verb form and a mapping to the corresponding entry in the verb form table. The display verb form table includes an entry for each verb in the target language. The entries include the verb forms in a format that is suitable for displaying and may also include a definition of the verb. The format may be an XML or HTML format that includes a complete conjugation of the verb in the base and target languages.

The search system includes a process search request component 1021, a perform search component 1022, an identify alternate spellings component 1023, a display verb forms component 1024, a display multiple verbs component 1025, and a display alternate spellings component 1026. The process search request component determines whether an input verb identifies a single verb, multiple verbs, or a misspelling. The component then invokes the display verb forms component, the display multiple verbs component, or the display alternate spellings component. The process search request component invokes the perform search component to perform the search. The process search request component also invokes the identify alternate spellings component to identify alternate spellings. The identify alternate spellings component may use conventional technology applied to a list of all possible forms and phrases in both the base language and target language to suggest alternate spellings.

The computing device on which the verb conjugating system is implemented may include a central processing unit, memory, input devices (e.g., keyboard and pointing devices), output devices (e.g., display devices), and storage devices (e.g., disk drives). The memory and storage devices are computer-readable media that may contain instructions that implement the verb conjugating system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the verb conjugating system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The verb conjugating system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

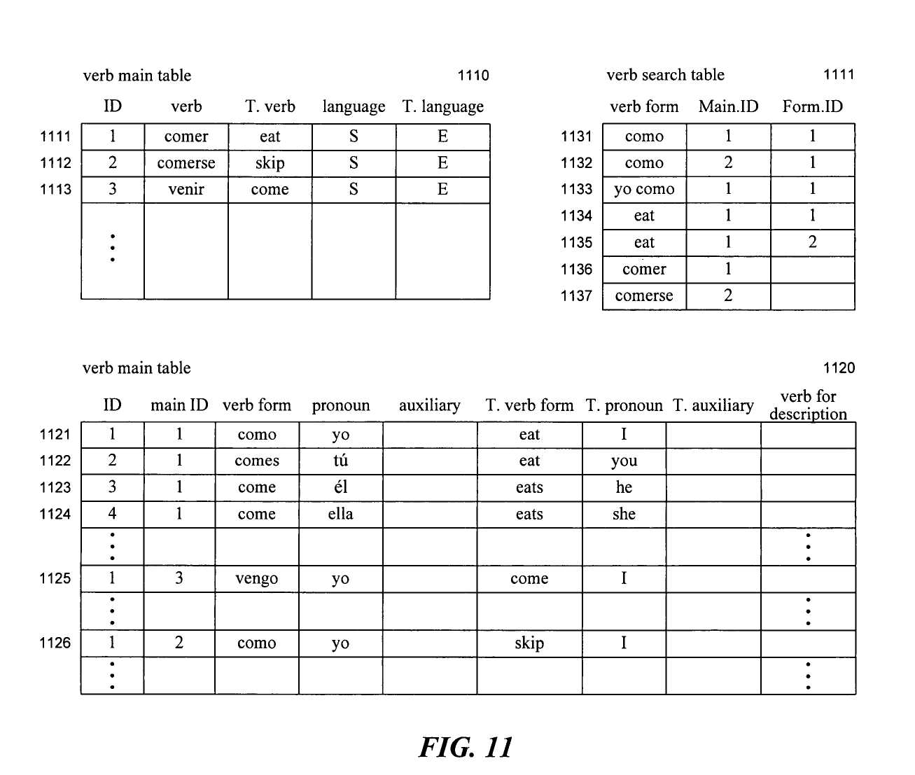

FIG. 11 is a block diagram that illustrates tables used by the search system of the verb conjugating system in one embodiment. A verb main table 1110 includes an entry for each verb in the target language. Each entry includes the infinitive form of the verb and its translation and an indication of its language. For example, entry 1111 of the table indicates that the verb is “comer,” the translated verb is “eat,” the verb is in Spanish, and the translated verb is in English. The verb form table includes an entry for each verb form in the target language. Each entry includes the verb form, its translation, and the verb form description, and may include a pronoun or an auxiliary and its translation. For example, entry 1121 of the table indicates that the verb form is “como,” the translated verb form is “eat,” the pronoun is “yo,” the translated pronoun is “I,” and the verb description (not shown) indicates a mood of indicative, a tense of present, a number of singular, a person of first, and a gender of masculine or feminine. The entry also includes a mapping to the corresponding verb in the verb main table. The verb search table includes an entry for each verb form and phrase that can be searched in both the base and target languages. The entries contain the verb form and an identifier to the corresponding entry in the verb form table. For example the first entry contains the verb “como” and a reference to entry 1121 of the verb form table.

The tables of FIG. 11 are used by the search system to identify the verb corresponding to the verb input by a user. When a user requests to search for a verb form or phrase, the search system uses a verb search table 1130 to identify the matching entries. For example, if the user enters “eat,” the search system will identify entries 1134 and 1135 of the verb search table. Those entries point to entries 1121 and 1122 of the verb form table 1120 (i.e., “como” and “comes”) corresponding to two different verb forms in Spanish that correspond to the verb form “eat” in English. Entries 1121 and 1122 of the verb form table reference entry 1111 of the verb main table. Because both entries reference the same entry in the verb main table, there is no ambiguity as to the verb that corresponds to “eat.” As such, the search system can then retrieve corresponding verb forms from the display verb form table and display them to the user. As another example, if the user requests a search on “como,” the search system will identify entries 1131 and 1132 of the verb search table. Those entries of the verb search table point to entries 1121 and 1126 of the verb form table. Those entries of the verb form table, however, point to different entries in the verb main table, that is entries 1111 and 1112 (i.e., “comer” and “comerse”). As a result, there is ambiguity as to the verb of interest. In such a case, the search system displays the infinitive forms of both verbs and possibly their definitions so that the user can select the verb of interest. As another example, if the user requests a search on “yo como,” the search system will identify entry 1133 of the verb search table. That entry points to entry 1121 of the verb form table, which points to entry 1111 of the verb main table. The search system then displays the verb forms corresponding to the verb of entry 1111 of the verb main table.

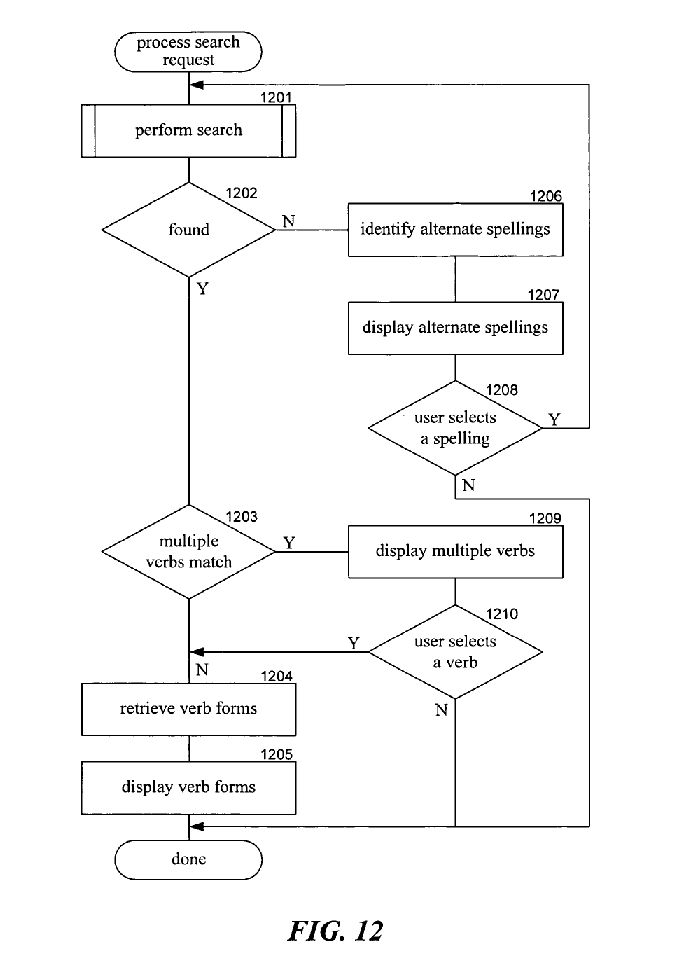

FIG. 12 is a flow diagram that illustrates the processing of the process search request component in one embodiment. The component is invoked when a user requests to search based on an input that may be either a verb form or a phrase. In block 1201, the component invokes the perform search component to identify all the verbs that match the input. In decision block 1202, if a verb matches the input, then the component continues at block 1203, else the component continues at block 1206. In decision block 1203, if multiple verbs match the input, then the component continues at block 1209, else only one verb matches the input and the component continues at 1204. In block 1204, the component retrieves the verb forms for the matching verb. In block 1205, the component invokes the display verb forms component to display the verb forms and then completes. In block 1206, the component invokes the identify alternate spellings component to identify alternate spellings of the input. In block 1207, the component invokes the display alternate spellings component to display the alternate spellings. In decision block 1208, if the user selects a spelling, then the component continues at block 1201 to perform a search, else the component completes. In block 1209, the component invokes the display multiple verbs component to display the multiple verbs that match the input. In decision block 1209, if the user selects a verb, then the component continues at block 1204 to retrieve the verb forms, else the component completes. The component then completes.

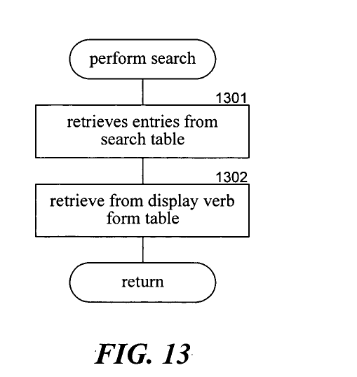

FIG. 13 is a flow diagram that illustrates the processing of the perform search component in one embodiment. In block 1301, the component retrieves all the entries from the search table that match the input. In block 1302, assuming at least one entry was retrieved, the component retrieves the corresponding entries from the verb form table corresponding to the retrieved entries of the search table. The component then returns.

From the foregoing, it will be appreciated that specific embodiments of the verb conjugating system have been described herein for purposes of illustration, but that various modifications may be made without deviating from the spirit and scope of the invention. One skilled in the art will appreciate that aspects of the verb conjugating system can be used for any type of language in which verbs are can be conjugated. Also, one skilled in the art will appreciate that the search system may not need the verb form table since the search table can map directly to the main verb table. One skilled in the art will also appreciate that the verb conjugating system may also allow a user to retrieve verb forms by inputting a description of a verb form. For example, the user may input “present indicative of sein,” “prãsens indikativ von sein,” “1st person plural of sein,” and “erste Person Plural von sein”.” Alternatively, the verb conjugating system may allow a user to select from a list of verb forms. To support such retrieval by description, the verb search table may be modified to include a description plus the infinitive form in each entry. One skilled in the art will appreciate that the verb conjugating system may use a base and/or target language selected by a user. Accordingly, the invention is not limited except as by the appended claims.

I/We claim:

1. A method in a computer system for conjugating verbs in a target language, the method comprising:
receiving a verb in a base language;
identifying verb forms in the target language using a translation of the received verb from the base language to the target language; and
displaying the identified verb forms in the target language.

2. The method of claim 1 including:
receiving a verb in the target language; and
identifying verb forms in the target language of the received verb in the target language.

3. The method of claim 1 including receiving a pronoun along with the verb.

4. The method of claim 1 including receiving an auxiliary along with the verb.

5. The method of claim 1 wherein the received verb is a non-infinitive form of a verb.

6. The method of claim 5 wherein the received non-infinitive form of the verb is highlighted when the verb forms are displayed.

7. The method of claim 1 including when the received verb is a misspelling of a verb form, displaying alternate spellings of a verb form.

8. The method of claim 7 including when a user selects a verb form with an alternate spelling, displaying the verb forms corresponding to the selected verb form in the target language.

9. The method of claim 1 including when the received verb matches different verbs, displaying an indication of the different verbs.

10. The method of claim 9 including when a user selects a different verb, displaying the verb form of the different verb in the target language.

11. The method of claim 9 including displaying a definition of the different verbs.

12. A computer-readable medium containing instructions for controlling a computer system to provide verb forms, by a method comprising:
receiving a verb form;
when the received verb form corresponds to different verbs, displaying the different verbs; and
when a user selects a different verb, displaying verb forms of the selected different verb.

13. The computer-readable medium of claim 12 wherein the displaying of the different verbs includes displaying a definition of a verb.

14. The computer-readable medium of claim 12 wherein the received verb form is a non-infinitive form of the verb.

15. The computer-readable medium of claim 12 wherein the indicated non-infinitive form of the verb form is highlighted when the verb forms are displayed.

16. The computer-readable medium of claim 12 wherein the received verb form is in a base language and the verb forms are displayed in a target language.

17. A computer-readable medium containing instructions for controlling a computer system to provide verb forms, by a method comprising:
receiving a phrase;
locating a verb that matches the received phrase; and
displaying verb forms of the located verb.

18. The computer-readable medium of claim 17 wherein the phrase includes a verb and a pronoun.

19. The computer-readable medium of claim 17 wherein the phrase includes a verb and an auxiliary.

20. The computer-readable medium of claim 17 wherein when multiple verbs match the phrase,
displaying the multiple verbs; and
when a user selects one of the multiple verbs, displaying verb forms of the selected verb.
